(19) United States
(12) Patent Application Publication
(10) Pub. No.: US 2021/0374678 A1
(43) Pub. Date: Dec. 2, 2021

(54) KANBAN-BASED WORK PROCESSING DEVICE AND WORK PROCESSING METHOD

(71) Applicants: Jae Ho CHOI, Seoul (KR); DELTA PDS CO., LTD., Seoul (KR)

(72) Inventor: Jae Ho CHOI, Seoul (KR)

(73) Assignees: DELTA PDS CO., LTD., Seoul (KR); Jae Ho CHOI, Seoul (KR)

(21) Appl. No.: 17/333,853

(22) Filed: May 28, 2021

(30) Foreign Application Priority Data
May 29, 2020 (KR) 10-2020-0065023
Jan. 13, 2021 (KR) 10-2021-0004630
Feb. 16, 2021 (KR) 10-2021-0020450
May 18, 2021 (KR) 10-2021-0064298

(51) Int. Cl. G06Q 10/10

(52) U.S. Cl. CPC G06Q 10/107; G06Q 10/103

(57) ABSTRACT

A Kanban-based work processing device includes: a Kanban board handling part that creates a new Kanban board; a Kanban card handling part that embeds a Kanban card for a created task project into the Kanban board; a work container handling part that embodies per-user-defined-work-type containers which associate the Kanban card with the task project; and a work handling part that performs user-defined work-based work communication between participants through a user-defined work container, which is one among the per-user-defined-work-type containers.

### CROSS-REFERENCE TO RELATED APPLICATIONS

This application claims priority to Korean Patent Application Nos. 10-2020-0065023 filed on May 29, 2020, 10-2021-0004630 filed on Jan. 13, 2021, 10-2021-0020450 filed on Feb. 16, 2021, and 10-2021-0064298 filed on May 18, 2021, which are all hereby incorporated by reference in their entirety.

### BACKGROUND

The present disclosure relates to a work processing and management technique, and more particularly, to a technique that provides effective support to perform work by providing a means of communication between task participants, such as a work chatroom for a Kanban board or work chat rooms for Kanban cards in the Kanban board.

Internet messengers generally refer to applications that deliver messages containing text or graphics between users, which may be implemented by a chat room where multiple users can join. In an embodiment, internet messengers may include mobile messengers that run in a mobile environment (e.g., mobile phone)—for example, KakaoTalk, Line, WeChat, and Facebook Messenger. Also, such internet messengers are becoming more and more diverse in use when it comes to work management and progress.

A Kanban board is one of the tools that can be used to implement Kanban to manage work at a personal or organizational level. Kanban boards visually organizes various stages of a task and subtasks in each stage of the task in a plane. Kanban boards use cards to arrange different stages of an entire process of a higher-level task in one direction to represent work items. For example, Kanban cards are moved from left to right through different stages of work to show progress.

Kanban is one of the software development processes, and its concept was originated from a development methodology that encourages developers to ship a product at right time without giving them much pressure.

### PRIOR ART DOCUMENT

### Patent Document

Korean Laid-Open Patent No. 10-2017-0040928 (published on 14 Apr. 2017).

### SUMMARY

The present disclosure provides a Kanban-based work processing device and work processing method that enable a user to see at a glance the progress of an ongoing project through a Kanban board, to give feedback on tasks and rework them in an effective way through a chat room uniquely associated with a Kanban card and a separate chat room associated with a task note, and to easily understand the workflow through task messages shared in chronological order, thereby improving the efficiency of work, and a storage medium storing the same.

An exemplary embodiment of the present disclosure provides a Kanban-based work processing device including: a Kanban board handling part that creates a new Kanban board; a Kanban card handling part that embeds a Kanban card for a created task project into the Kanban board; a work container handling part that embodies per-user-defined-work-type containers which associate the Kanban card with the task project; and a work handling part that performs user-defined work-based work communication between participants through a user-defined work container, which is one among the per-user-defined-work-type containers.

The Kanban card handling part may embed a new Kanban card into the Kanban board each time the created task project is detected.

The work container handling part may implement the user-defined work container in such a way that a corresponding user-defined work type is handled exclusively through the user-defined work container.

The work container handling part may assign a unique identity link to the user-defined work container and support direct transitions between the per-user-defined-work-type containers through the user-defined work.

The work container handling part may implement one of the per-user-defined-work-type containers as a work chat room-only container.

The work handling part may embody a work chat room associated with the task project in the work chat room-only container.

The work handling part may embody a user-defined work chat room associated with the user-defined work in the work chat room-only container.

The work handling part may implement the user-defined work by a text or binary file-based task message and provide the task message to the work chat room.

When an event occurs from other user-defined work, the work handling part may implement the user-defined work by a system message and provide the task message to the work chat room.

The work handling part may register a reminder event by tracking the progress of a conversation in the task message.

The work container handling part may implement one of the per-user-defined-work-type containers as a task note-only container.

The work handling part may implement the user-defined work by a text or binary file-based task note and curate the task note in the task note-only container according to user settings.

The work handling part may create a task note event when the task note is created.

The work container handling part may implement one of the per-user-defined-work-type containers as a task object-only container.

The work handling part may implement the user-defined work by a task object and implement the task object in the task object-only container.

When a task object is provided to a certain chat room in the work chat room-only container, the work handling part may create a task object event.

The work handling part may register a reminder event by tracking the progress of work in the task object based on workflow.

The work handling part may detect the registration of a reminder event that has occurred from the user-defined work.

The work handling part may create a reminder setting for the reminder event and provide a reminder message to the work chat room according to the reminder setting.

The work handling part may create a reminder message by setting a reminder for the status of progress of user-defined work assigned to at least some of the participants of the task project.

The work handling part may update the reminder message based on the number of repetitions of the same reminder message.

If a plurality of tasks are sequentially linked according to a sequence of work, the work handling part may create an integrated reminder message reflecting the sequence of work and allow the same to be shared through the work chat room.

If an external user not authorized for access is invited to the work chat room, the external user may be allowed access only to the work chat room.

Another exemplary embodiment of the present disclosure provides a Kanban-based work processing method including: creating a new Kanban board; embedding a Kanban card for a created task project into the Kanban board; embodying per-user-defined-work-type containers which associate the Kanban card with the task project; and performing user-defined work-based work communication between participants through a user-defined work container, which is one among the per-user-defined-work-type containers.

### BRIEF DESCRIPTION OF THE DRAWINGS

FIG. is a view illustrating a work processing system according to the present disclosure.

FIG. 2 is a view illustrating a system configuration of the work processing device of FIG. 1.

FIG. 3 is a view illustrating a functional configuration of the work processing device of FIG. 1.

FIG. 4 is a sequential chat of a Kanban-based work processing method according to the present disclosure.

FIG. 5 is a view illustrating a Kanban board according to an exemplary embodiment of the present disclosure.

FIG. 6 is a view illustrating a Kanban card according to an exemplary embodiment of the present disclosure.

FIGS. 7A-7D are views illustrating a work chat room and a task message sharing process.

FIGS. 8 and 9 are flowcharts illustrating various examples of sharing task messages in a Kanban-based work processing process according to the present disclosure.

FIG. 10 is a view illustrating a reminder sharing process according an exemplary embodiment of the present disclosure.

### DETAILED DESCRIPTION

The description of the present disclosure is merely an example for structural or functional explanation, and therefore, the scope of the present disclosure should not be construed as being limited by the embodiments described in the text. That is, since the embodiments can be variously embodied and have various forms, the scope of the present disclosure should be understood to include equivalents capable of realizing technical ideas. Also, since the purpose or effect set forth in the present disclosure is not intended imply that to the specific embodiment, the scope of the present disclosure should not be construed as being limited thereto.

Meanwhile, the meaning of the terms described in the present application should be understood as follows.

The terms such as “the first”, “the second”, and the like, are intended to distinguish one element from another, and the scope of the right should not be limited by these terms. For example, the first component may be referred to as the second component, and similarly, the second component may also be referred to as the first component.

It is to be understood that when an element is referred to as being “connected” to other element, it may be directly connected to the other element, but there may also be other elements in between. On the other hand, when an element is referred to as being “directly connected” to other element, it should be understood that there is no other element in between. On the other hand, other expressions that describe the relationship between elements, that is, “between˜” and “just between˜” or “adjacent to˜” and “directly adjacent to˜” should be interpreted likewise as well.

The singular expressions should be understood to include plural expressions unless the context clearly dictates otherwise. It is also to be understood that the terms “comprise”, “include”, “have”, and the like, are to designate the presence of practiced features, numbers, steps, operations, elements, parts, or combinations thereof, but do not preclude the presence or addition, possibility of one or more other features, numbers, steps, operations, elements, parts, or combinations thereof.

In each step, the identification code (e.g., a, b, c, etc.) is used for convenience of explanation, but the identification code does not describe the order of each step, and unless otherwise explicitly stated, it may occur differently from the stated order. That is, each of steps may occur in the same order as described, may also be performed substantially at the same time, and may be performed in reverse order.

The present disclosure can be embodied as a computer-readable code on a computer-readable recording medium, and the computer-readable recording medium includes all kinds of recording devices for storing data, which can be read by a computer system. Examples of the computer-readable recording medium include ROM, RAM, CD-ROM, magnetic tape, floppy disk, optical data storage device, and the like. In addition, the computer-readable recording medium may be distributed over network-connected computer systems so that computer readable codes can be stored and executed in a distributed manner.

All terms used herein have the same meaning as commonly understood by one of ordinary skill in the art to which this invention belongs, unless otherwise defined. Terms defined in commonly used dictionaries should be interpreted to be consistent with meaning in the context of the related art and cannot be interpreted as having ideal or overly formal meaning unless explicitly defined in the present application.

FIG. 1 is a view illustrating a work processing system according to the present disclosure.

Referring to FIG. 1, the work processing system 100 may include a plurality of user terminals 110 and a work processing device 130.

In an exemplary embodiment of the present disclosure, a plurality of users may be included in one or more user groups. One or more user groups may be referred to as a first user group, a second user group, and so on. One user may be included in one or more user groups.

A first user terminal 110a is a terminal of a first user. A second user terminal 110b may correspond to a terminal of a second user, a third user terminal 110c may correspond to a terminal of a third user, and a fourth user terminal 110d may correspond to a terminal of a fourth user.

Here, the first through fourth users may collaborate as participants on one or more Kanban boards. For a task performed through one Kanban board, one or more of the first through fourth users may be task owners, and another one or more of them may be task assignees. Other participants apart from the task owner(s) and the task assignee(s) may be classified as task followers.

The first through fourth users may collaborate on an entire project, and the entire project may progress in stages through a Kanban board. Also, there may be multiple task projects that are included in or subordinate to the entire project. Moreover, there may be one or more subtasks that are included in or subordinate to each task project. Big and small pieces of work may be created as subtasks in the process of carrying out the task project, and they may be referred to as task objects (or tasks).

These task objects may be uploaded and managed on Kanban cards. That is, one task project may progress in stages through a Kanban card, and different task objects subordinate to the task project may be performed and managed through task notes uploaded onto the Kanban card. Also, the task project may go through a number of phases of work progress which are classified based on its progress or status.

For example, the phases of work progress may include “in progress”, “under review”, “reworking”, and “rework completed” according to the PDCA cycle. The PDCA cycle is known as a systematic and efficient work management approach used to improve work performance and outcomes. “P” stands for Plan—that is, setting objectives for projects (or tasks) and establishing concrete strategies and activity plans to realize the objectives. “D” stands for Do—that is, practically performing work on planned items according to rules, guidelines, standards, etc. “C” stands for Check, which means checking work results from the D phase and analyzing and evaluating them to see any differences with the original goals and find parts that need to be improved or reworked. “A” stands for Act, in which necessary measures can be taken for improvement and rework, such as modifying the existing work results or reworking the task to address the problems and opportunities for improvement identified in the previous C phase.

That is, once the details of an assignment are uploaded onto a Kanban card by the task owner (Plan, P), the Kanban card moves into the “in progress” phase. When the task assignee has completed the task as assigned by the task owner and uploaded the completed task (Do, D), the Kanban card moves into the “under review” phase. In this case, task-related information entered by the task owner or task assignee may be written as a task note and uploaded onto the Kanban card, and both the writing and the uploading may change the status of the Kanban card. Moreover, task-related information subordinate to the task note may be created as a task object, i.e., a task, and managed in association with the task note, and an update to the task object may lead to an update to the associated task note and Kanban card.

Moreover, the task owner may review a completed task in the “under review” Kanban card” (Check, C) and close the task. In this case, the Kanban card may move to the “closed” phase. Alternatively, the task owner may ask the task assignee to rework the completed task after reviewing it. Once a rework request or a rework instruction is uploaded onto the Kanban card by the task owner, the Kanban card may move to the “reworking” phase, and the status of the Kanban card may be changed as well.

In a case where the task assignee has reworked the completed task as instructed by the task owner (Act, A), once the reworked task is uploaded onto the Kanban card by the task assignee or the uploaded reworked task is confirmed by the task owner, the Kanban card may be set to the “rework completed” phase. Also, individual Kanban cards may be classified according to the phases of work progress and arranged in the Kanban board.

The work processing device 130 corresponds to a computing device that can be connected to at least one user terminal 110 over a network. In an exemplary embodiment, the work processing device 130 may manage at least one user group in which other users associated with one user are included as team members, i.e., task participants.

In an exemplary embodiment, the work processing device 130 may be connected to a user terminal 110 through a shared folder agent installed on the user terminal 110. Here, the shared folder agent corresponds to an agent program, which is a type of software that, when installed, allows the user terminal 110 and the work processing device 130 to interoperate with the approval of the user terminal 100.

A folder or file to be shared may be, but not limited to, located within a shared folder provided by the work processing device 130. A folder or file to be shared may be located in a shared folder provided by the work processing device 130 or in a personal folder of a file sharer. The user terminal 110 may correspond to a computing device that may be connected to the work processing device 130 over a network—for example, a terminal that is implemented as a desktop, a laptop, a tablet PC, or a smart phone.

In an exemplary embodiment, at least one of the user terminals 110 may be a mobile terminal and connected to the work processing device 130 via cellular communication or WiFi communication. In another exemplary embodiment, at least one of the user terminals 110 may be a desktop and connected to the work processing device 130 through the internet.

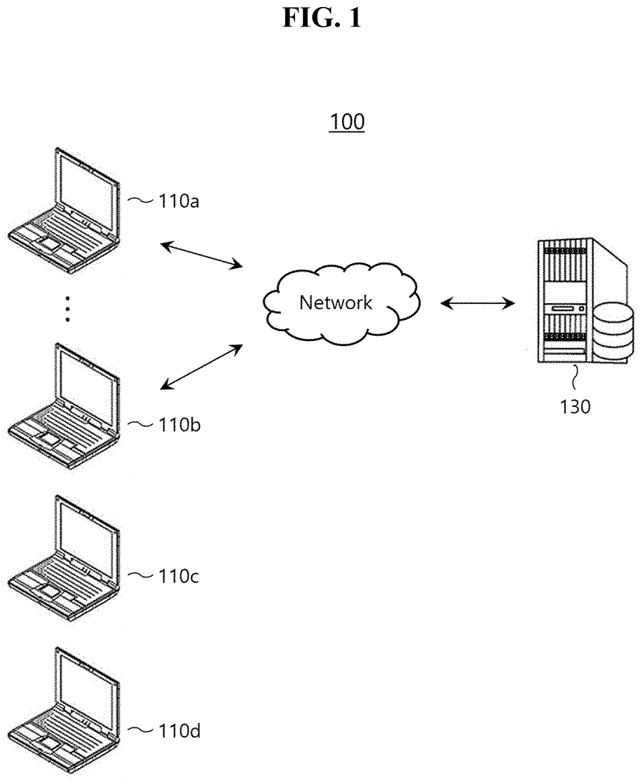

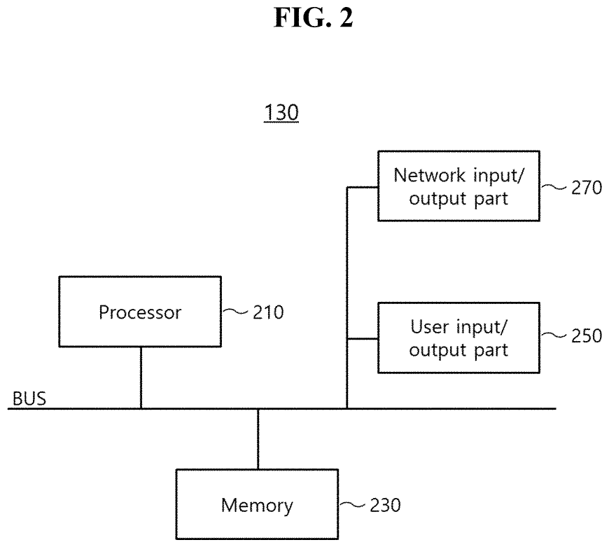

FIG. 2 is a view illustrating a system configuration of the work processing device of FIG. 1.

Referring to FIG. 2, the work processing device 130 may include a processor 210, a memory 230, a user input/output part 250, and a network input/output part 270.

The processor 210 may execute a work schedule display procedure according to an exemplary embodiment of the present disclosure, manage the memory 230 from or to which data is read or written during this process, and schedule a time for synchronization between volatile memory and nonvolatile memory in the memory 230.

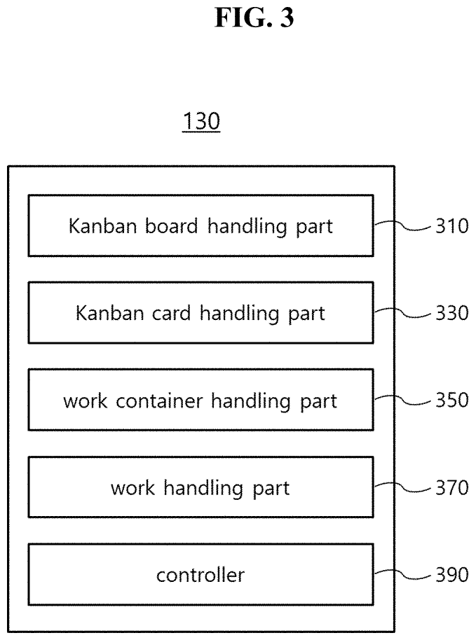

The processor 210 may control the overall operation of the work processing device 130, and may be electrically connected to the memory 230, the user input/output unit 250, and the network input/output part 270 to control the flow of data between them. The processor 210 may be implemented as a central processing unit (CPU) of the work processing device 130. More specific details of the operation of the processor 210 will be described in details later with reference to FIG. 3.

The memory 230 may include auxiliary storage which is implemented as nonvolatile memory such as a solid state disk (SSD) or a hard disk drive (HDD) and used to store all data required for the work processing device 130, and may include primary storage which is implemented as volatile memory such as random access memory (RAM). This way, the memory 230 may be implemented as volatile and nonvolatile memory, and may be connected by a hyperlink if implemented as nonvolatile memory.

The user input/output part 250 may include an environment for receiving user input and an environment for outputting specific information to the user. For example, the user input/output part 250 may include an input device including an adapter such as a mouse, a trackball, a touchpad, a graphics tablet, a scanner, a touchscreen, a keyboard, or a pointing device or connected to that adapter and an output device including an adapter such as a monitor or a touchscreen. In an exemplary embodiment, the user input/output unit 250 may correspond to a computing device connected via remote access, in which case the work processing device 130 may serve as a server.

The network input/output part 270 may include an environment for connecting to a user terminal 120 over a network—for example, an adapter for local area network (LAN) communication.

FIG. 3 is a view illustrating a functional configuration of the work processing device of FIG. 1.

Referring to FIG. 3, the processor 210 of the work processing device 130 may include a Kanban board handling part 310, a Kanban card handling part 330, a work container handling part 350, a work handling part 370, and a controller 390.

However, the processor 210 according to the exemplary embodiment of the present disclosure does not necessarily include all of the above components, and some of the above components may be omitted depending on each exemplary embodiment and the processor 210 may selectively include some or all of the above components.

The Kanban board handling part 310 may create a user-based Kanban board. That is, a Kanban board may be created corresponding to an entire project, and various task projects created along with the progress of the entire project may be classified and managed according to the phases of work progress. The task projects may be created respectively corresponding to the Kanban cards and embedded into the Kanban board.

Moreover, the Kanban board handling part 310 may be accessed by a user group of one or more users, and may receive a user selection signal from a user terminal 110 to select a Kanban board provided through the user terminal 110 or one or more Kanban cards within the Kanban board.

More specifically, the Kanban board handling part 310 saves, manages, and updates user information of users participating in a Kanban board by receiving user information on one or more users from the user terminal 110 via the user input/output part 250. The Kanban board handling part 310 may provide user information it has collected to create the Kanban board, at various steps of operation which are required later for project management, including handling Kanban cards, creating task notes, creating task objects, creating work chat rooms, and creating reminder messages.

Also, the Kanban board handling part 310 may mange schedules for performing work and rework according to given work instructions and rework instructions entered by the user terminal 110. For example, if a work instruction or rework instruction uploaded by the task owner contains information about a deadline or a Kanban board or a Kanban card is set with a work schedule, information related to the schedule or deadline may be collected and managed.

Additionally, if necessary, the Kanban board handling part 310 may provide user information it has collected to create the Kanban board, in the process of managing work schedules related to the Kanban board or Kanban cards. The Kanban board handling part 310 may provide necessary user information when creating or running a work chat room as well.

Furthermore, the Kanban board handling part 310 may create user groups for work chat rooms if required, and may save and manage information such as names of user groups, criteria for user group classification, team members, information for identification of chat rooms that match different user groups, classifications or divisions of users by group, and information on the management of authorization of users or user groups.

That is, if a user's user group differs depending on the user's division or position, the Kanban board handling part 310 may set identification information of user groups that match their division, department, or position, or, if a user group is designated for each individual user, the Kanban board handling part 310 may save information on the designated user group.

Furthermore, the Kanban board handling part 310 may set or save information about each user's authorization to access, open, and edit chat rooms, files, Kanban cards, or Kanban boards. A Kanban board may be configured such that only the users of a certain user group access it. In this case, only users who are authorized to access the corresponding Kanban board may be designated as participants in chat rooms associated with the Kanban board, Kanban card, and task note.

If an external user with no authorization to access the Kanban board is invited to join a work chat room, the external user may obtain authorization to access the corresponding Kanban board, Kanban card, or task note. In this case, their authorization to access the Kanban board, Kanban card, or task note may be limited. For example, an external user may access only through a work chat room, but the authorization of access obtained through a work chat room associated with a particular Kanban card may give them no access to other Kanban cards within the same Kanban board. Similarly, the authorization of access obtained through a work chat room associated with a particular task note may give them no access to other task notes within the same Kanban card.

In an exemplary embodiment, the Kanban board handling part 310 may save and manage various documents, data, and materials (hereinafter, “work materials”) uploaded onto the Kanban board by users, in relation to the work they are assigned or dealing with. When a chat room is created in relation to an uploaded work material, the work material may be provided to the user terminal 110, along with chat room information embedded in it.

In an exemplary embodiment, the Kanban board handling part 310 may provide the user terminal 110 a user interface for receiving work material or user signals related to the Kanban board. The Kanban board handling part 310 may receive user signals including either or both of a signal requesting to create an entire project and a deadline setting signal from the user terminal 110 via the user interface.

If there are one or more work chat rooms created in relation to the Kanban board, the Kanban board handling part 310 may display a list of associated chat rooms, along with the corresponding Kanban board. Also, along with the list of work chat rooms for the Kanban board, the Kanban board handling part 310 may provide access routes to the corresponding chat rooms as hyperlink information.

Moreover, the Kanban board may include first through third integration containers which provide integrated management of task notes, work chat rooms, and task objects created in association with multiple Kanban cards. That is, the task notes created in association with the Kanban cards may be embedded into the first integration container for integrated management, and the work chat rooms and the task objects may be embedded into the second and third integration containers, respectively, for integrated management. As a result, the first integration container may correspond to a task note integration container, the second integration container may correspond to a work chat room integration container, and the third integration container may correspond to a task object integration container. In an exemplary embodiment, the first through third integration containers may correspond to DO, CHECK, and ACT tabs to provide management according to the phases of work progress.

In an exemplary embodiment, the Kanban board handling part 310 may set a curation feature on the first through third integration containers individually according to the user's preference. Here, the curation feature may involve presenting relevant information when the user looks up a task note, work chat room, or task object associated with the Kanban board.

In an exemplary embodiment, when external sharing is enabled for a task note, a work chat room, and a task object, the Kanban board handling part 310 may create a uniquely accessible permanent link and embed it into the task note, the work chat room, and the task object and allow it to be shared through the first through third integration containers. Here, the permanent link may correspond to a link that enables direct access to the task note, the work chat room, and the task object without indirect access from the outside through the Kanban card. That is, Kanban cards may be configured by default to only authorize the participants in the task project to have access. Thus, an outsider not involved in the task project may be restricted from access to the task note, the work chat room, and the task object, unless they are authorized to access the Kanban card.

Nevertheless, external sharing may be enabled for the task note, the work chat room, and the task object, individually, in which case a permanent link for external sharing may be created and added to the task note, the work chat room, and the task object.

For example, the task note may be shared through the DO tab (or first integration container) in the Kanban board, and the participants may have direct access by choosing the task note on the DO tab. The work chat room may be shared through the CHECK tab (or second integration container) in the Kanban board, and the participants may have direct access by choosing the work chat room on the CHECK tab. The task object may be shared through the ACT tab (or third integration container) in the Kanban board, and the participants may have direct access by choosing the task object on the ACT tab.

In addition, the above description of the operation of the Kanban board handling part 310 may apply equally to other components, that is, the Kanban card handling part 330, the work container handling part 350, and the work handling part 370, and redundant explanations will be omitted hereinafter.

The Kanban card handling part 330 may embed a Kanban card into a Kanban board when a task project is created. The Kanban card handling part 330 may detect the creation of a task project from a Kanban board and automatically create a Kanban card for the management of the task project. That is, a Kanban card may be created for each individual task project that is created along with the progress of an entire project, and the status of the Kanban card may be updated in sync with the progress of the corresponding task project. The Kanban card handling part 330 may receive user information collected for the creation of a Kanban board from the Kanban board handling part 310.

The Kanban card handling part 330 may embed a Kanban card into the Kanban board to manage a particular task project. That is, the Kanban card handling part 330 may control and handle operations associated with the Kanban card, as well as providing basic management functions such as creating, modifying, and deleting the Kanban card. A Kanban card created by the Kanban card handling part 330 may be embedded into the Kanban board, and may be used to carry out the task project and manage records.

Meanwhile, the Kanban card may include at least one dedicated container that manages task notes, work chat rooms, and task objects separately. Here, the task notes, the work chat rooms, and the task objects may correspond to user-defined work, and the Kanban card may be implemented to selectively include per-user-defined-work-type containers.

Moreover, once the details of an assignment or a rework instruction is uploaded onto a Kanban card, the Kanban card handling part 330 may make this Kanban card look different from how it looked before the details of the assignment or the rework instruction is uploaded. In this case, the user is able to know intuitively whether the details of a new assignment or a rework instruction has been uploaded or not, just by seeing how the Kanban card looks.

In an exemplary embodiment, a Kanban card may be configured by setting reminders to periodically create task notes or reminders for a workflow-based deadline. The Kanban card may be defined to include a preset task requirement according to the type of the task project. That is, reminders may be set to initiate the creation of reminder messages provided through a work chat room according to the progress of work, and reminders may be set to urge the participants to perform certain actions. For example, a Kanban card may include a task requirement that requires task notes to periodically occur along with the progress of work or a task requirement that requires a task to be done before a set deadline according to the workflow.

Moreover, a Kanban card may include, as user-defined work, task notes for sharing basic information about the task between the participants, task objects for sharing assigned tasks between the participants, and a plurality of work chat rooms associated with the corresponding Kanban card or task notes.

In this case, the Kanban card may manage the plurality of task notes, work chat rooms, and task objects in lists, and may include dedicated containers (i.e., per-user-defined-work-type containers) for them.

Basically, the participants in the corresponding task project may have limited access to the work chat rooms associated with the Kanban card. That is, Kanban cards may be used as a means of recording and managing the whole procedure of each task project, and may be used as a means for managing tasks for the entire project within the Kanban board.

In an exemplary embodiment, the Kanban board handling part 310 may set a curation feature on the first through third integration containers individually according to the user's preference. Here, the curation feature may involve presenting relevant information when the user looks up a task note, work chat room, or task object associated with the Kanban board.

For example, the Kanban card handling part 330 may arrange and present task notes in chronological order or in order of importance. Also, the Kanban card handling part 330 may arrange and present one-on-one work conversations with a particular person in a work chat room. Also, the Kanban card handling part 330 may arrange and present task objects by task owner or task assignee. Meanwhile, the Kanban card handling part 330 may decide the way the dedicated containers are curated, according to settings entered directly by the user.

The work container handling part 350 may embody per-user-defined-work-type containers which associate the Kanban card with the task project. Here, the user-defined work may include task notes, work chat rooms, and task objects, and the per-user-defined-work-type containers may include a task note-only container (or first dedicated container), a work chat room-only container (or second dedicated container), and a task object-only container (or third dedicated container).

That is, the work container handling part 350 may embody a work chat room-only container (second dedicated container) for the task project by default, in response to the creation of the Kanban card. The embodying operation may involve a series of concrete processes for creating a work chat room-only container and associating it to the Kanban card. That is, the work container handling part 350 may implement one of the per-user-defined-work-type containers as a work chat room-only container, and therefore a unique work chat room may be linked to the Kanban card. As such, the participants in the task project may share various messages.

Moreover, as well as the work chat room-only container, the work container handling part 350 may selectively embody the task note-only container or the task object-only container as one of the per-user-defined-work-type containers if necessary. That is, the work container handling part 350 may implement one of the per-user-defined-work-type containers as a task note-only container (or first dedicated container) or may implement one of the per-user-defined-work-type containers as a task object-only container (or third dedicated container).

In an exemplary embodiment, the work container handling part 350 may implement a user-defined work container in such a way that a corresponding user-defined work type is handled exclusively through the user-defined work container. For example, if the user-defined work is a task note, the user-defined work container may correspond to the task note-only container. Also, if the user-defined work is a work chat room, the user-defined work container may correspond to the work chat room, and if the user-defined work is a task object, the user-defined work container may correspond to the task object-only container. That is, the work container handling part 350 may implement a user-defined work container by embodying it, and the user-defined work container may be embedded into the Kanban card for management.

In an exemplary embodiment, the work container handling part 350 may assign a unique identity link to the user-defined work container and support direct transitions between the per-user-defined-work-type containers through the user-defined work. For example, first through third links may be assigned as unique identity links to the task note-only container, the work chat room-only container, and the task object-only container. In this case, If Task Note n1 with a first link is shared through Work Chat Room C2, the user may look up and choose Work Chat Room C2 in the work chat room-only container, and may move directly to the task note-only container associated with Task Note n1 via the first link to Task Note n1 shared in Work Chat Room C2. That is, the user may move easily between the per-user-defined-work-type containers by using the unique identity links to the user-defined work.

The work handling part 370 may perform user-defined work-based work communication between participants through a user-defined work container, which is one among the per-user-defined-work-type containers. Various types of user-defined work may be created and used between the participants throughout the progress of the task project, and the user-defined work may be shared between the participants through each user-defined work container. That is, the participants may share various messages through a work chat room throughout the progress of the task project, and may perform user-defined work-based work communication by creating task notes and task objects and managing and sharing the progress of work.

In an exemplary embodiment, the work handling part 370 may embody a work chat room (i.e., first work chat room) associated with the task project in the work chat room-only container. In an exemplary embodiment, the work handling part 370 may embody a user-defined work chat room (i.e., second work chat room) associated with the user-defined work in the work chat room-only container. In this instance, if the user-defined work is a task note, the user-defined work chat room may correspond to a task note-based work chat room.

In an exemplary embodiment, the work handling part 370 may implement the user-defined work by a text or binary file-based task message and provide the task message to the work chat room. For example, when a task note or a task object is created as the user-defined work, based on text typed by a participant or a binary file uploaded by a participant, a task message associated with this creation may be provided to the work chat room.

In an exemplary embodiment, when an event occurs from other user-defined work, the work handling part 370 may implement this user-defined work by a system message and provide the task message to the work chat room. For example, when an event for the creation of a task note or task object occurs through other work chat room, a task message associated with this creation may be provided to the work chat room.

In an exemplary embodiment, the work handling part 370 may register a reminder event by tracking the progress of a conversation in the task message. For example, task messages shared through a work chat room may include explicit designation messages which specify a particular user and indirect designation messages which do not explicitly specify a particular user but indirectly indicates that person. The work handling part 370 may create a reminder setting by analyzing a task message, and create and register a reminder event according to the reminder setting.

In an exemplary embodiment, the work handling part 370 may implement the user-defined work by a text or binary file-based task note and curate the task note in the task note-only container according to user settings. Task notes embedded into the task note-only container may be arranged in a predetermined order of priority according to user settings, and may be displayed in that order of priority in response to a lookup request from the user.

In an exemplary embodiment, the work handling part 370 may create a task note event when a task note is created. In an exemplary embodiment, the work handling part 370 may implement the user-defined work by a task object and implement the task object in the task object-only container. In an exemplary embodiment, when a task object is provided to a certain chat room in the work chat room-only container, the work handling part 370 may create a task object event.

In an exemplary embodiment, the work handling part 370 may register a reminder event by tracking the progress of work in the task object based on workflow. In an exemplary embodiment, the work handling part 370 may detect the registration of a reminder event that has occurred from the user-defined work. In an exemplary embodiment, the work handling part 370 may create a reminder setting for the reminder event and provide a reminder message to the work chat room according to the reminder setting.

More specifically, when a predetermined reminder event occurs from the user-defined work and is registered, the work handling part 370 may detect the registration of the reminder event. Once the registration of the reminder event is detected, the work handling part 370 may create a reminder setting and create a reminder message according to the reminder setting and allow it to be shared with the participants through the work chat room.

In an exemplary embodiment, the work handling part 370 may create a reminder message by setting a reminder for the status of progress of user-defined work assigned to at least some of the participants of the task project. The status of progress of user-defined work may be defined as scheduled, in progress, overdue, and confirmed, and a deadline may be set according to the status of the progress of work. The work handling part 370 may create and send a reminder message to the participants associated with this user-defined work as the deadline associated with each status of work progress approaches.

In an exemplary embodiment, the work handling part 370 may update the reminder message based on the number of repetitions of the same reminder message. That is, the work handling part 370 may create and provide a reminder message according to the reminder setting. If the same reminder message recurs repeatedly, the cumulative number of repetitions of the reminder message may be counted, and the reminder message may be updated based on the count.

In an exemplary embodiment, if a plurality of tasks are sequentially linked according to a sequence of work, the work handling part 370 may create an integrated reminder message reflecting the sequence of work and allow it to be shared through the work chat room (e.g., first work chat room). For example, if to-dos associated with the Kanban card are defined as a plurality of tasks and are sequentially linked together, the work handling part 370 may create a reminder message according to the sequence of the tasks and allow it to be shared. Once a preceding task is completed, the work handling part 370 may create a reminder message about a subsequent task and allow it to be shared.

In an exemplary embodiment, if an external user not authorized for access is invited to the work chat room, the external user may be allowed access only to the work chat room.

In an exemplary embodiment, the work handling part 370 may be implemented to include a plurality of subcomponents that perform operations related to task notes, work chat rooms, and task objects separately as user-defined work. For example, the work handling part 370 may be implemented to include a task note handling part 371, a work chat room handling part 373, and a task object handling part 375. The work handling part 370 may be implemented in various combinations of the task note handling part 371, the work chat room handling part 373, and the task object handling part 375, and it is needless to say that the work handling part 370 may be implemented as a single independent component if necessary. Hereinafter, concrete operations of the components will be described.

The task note handling part 371 may create task notes in the first dedicated container so that the participants in a particular task project share basic information about the task. The participants may create task notes via a dedicated interface provided in a work chat room associated with the Kanban card or via a dedicated interface provided in the first dedicated container (or the DO tab of the Kanban card). The created task note may be saved in association with the corresponding Kanban card, and may be added to the first integration container of the Kanban board and shared as basic information about the task between the participants of the entire project. The task notes may contain basic information about the task to keep track of the progress of the task project or brief comments to keep the participants informed.

Moreover, the task note may be created in file format, and a file created or uploaded by a participant may be defined as a separate task note and added to the Kanban card. For example, the first dedicated container may provide an interface for creating task notes, and, when a file is uploaded by a participant, the file may be converted into a task note and shared with other participants.

In an exemplary embodiment, the task note handling part 371 may create task notes, which are drawn up by participants and generated throughout the progress of the task project, and embed the task notes in chronological order in the first dedicated container. A task note may be saved in association with one or more Kanban cards, and may be managed through the first integration container of the Kanban board according to the phases of progress of the entire project. To this end, the task note handling part 371 may embed task notes into the first dedicated container in chronological order based on the date of creation.

In an exemplary embodiment, the task note handling part 371 may provide a task message containing a permanent link to a task note in a work chat room. Here, the work chat room may correspond to a work chat room shared via the second integration container of the Kanban board by default. That is, records on the task note may be shared as task messages through a work chat room uniquely linked to the Kanban card. If external sharing is enabled and a permanent link is embedded into a task note, this permanent link may be embedded into a task message associated with the corresponding task note as well. Since the work chat room through which this task message is shared is shared outside the Kanban card through the second integration container, so that other people who do not participate in the task project may access the corresponding task note via the permanent link in the task message.

The work chat room handling part 373 may create a work chat room where the participants in the task project join, in the second dedicated container (or work chat room-only container), and share chat messages and task messages and reminder messages for created task notes and task objects in the work chat room. The work chat room may include a first work chat room associated with a Kanban card and a second work chat room associated with a task note.

That is to say, once a task note is created, the work chat room handling part 373 may create a second work chat room associated with the task note in the second dedicated container and allow chat and task messages about the task note to be shared between the participants. That is, the second work chat room may correspond to a work chat room uniquely linked to a particular task note. Therefore, the work chat room handling part 373 may create a second work chat room each time a new task note is created within one Kanban card and embed it into the second dedicated container, and the participants associated with the task note may join the second work chat room and share conversations about the task note.

Meanwhile, the second work chat room may allow task messages to be shared, as well as conversations about the task note, and provide a task object creation function. That is, a task object (or task) created in association with the task note may be created via a dedicated interface provided within the second work chat room. Therefore, logs (including creations, modifications, and deletions) on multiple task objects associated with one task note may be shared as task messages with other participants through the second work chat room. Also, the task messages shared through the second work chat room may include a first reminder message for a task object.

Moreover, the work chat room handling part 373 may save and manage access rights to each work chat room, participants in conversations, and message threads transmitted through work chat rooms. For example, the work chat room handling part 373 may save chat messages transmitted or shared through work chat rooms and work materials such as shared files or folders and save routes for accessing them. That is, the work chat room handling part 373 may save data related to each work chat room, and, even if a particular work chat room is temporarily or permanently is closed, may save data related to this work chat room. Also, if this work chat room re-opens later, the data related to the work chat room may be provided. Moreover, the work chat room handling part 373 may process the work chat room in the form of a file object when saving it.

In addition, the work chat room handling part 373 may provide the number of unread messages for each of users participating in a work chat room, such as those involved in the task, by counting at least either chat messages or notification signals that were transmitted to the users through the work chat room, but that they haven't read yet.

Here, if there are one or more work chat rooms created in association with a particular Kanban card or task note, the work chat room handling part 373 may provide the number of unread messages in each work chat room, along with a list of work chat rooms. The work chat room handling part 373 may show a list of work chat rooms and the number of unread messages in each chat room together in the Kanban board.

In an exemplary embodiment, when a Kanban card is created, the work chat room handling part 373 may create a first work chat room associated with this Kanban card in the second dedicated container and allow conversations about the task project and task messages about task notes to be shared between the participants. That is, the first work chat room may correspond to a work chat room uniquely linked to a particular Kanban card. Thus, the work chat room handling part 373 may provide one first work chat room within one Kanban card, and the participants associated with the Kanban card may participate in the first work chat room and share information about all activities of the task project through task messages.

For example, the first work chat room may provide information on note logs, conversations, task logs, etc. associated with the corresponding Kanban card in the form of messages. Accordingly, the participants may see logs of all activities for the corresponding task project by viewing task messages, and also may see message logs that are organized in chronological order or by task assignee or task owner. Also, the task messages shared through the first work chat room may include second reminder messages about task notes.

In an exemplary embodiment, the work chat room handling part 373 may create a task link for immediate access to a task object in the process of creating a task message and embed it into the corresponding task message. The created task message may be shared through the corresponding work chat room, and the participants in this work chat room may directly access the corresponding task object and easily see related details of the task without access through the task link included in the task message.

Meanwhile, even someone who is able to join the work chat room and see task messages with task links embedded in them may have no access via these task links unless they are authorized to access the corresponding task object. For example, a task message with a task link embedded in it may be shared with participants associated with the Kanban card through the first work chat room, and participants not associated with the corresponding task object may have no access to the corresponding task object, even if they have access to the first work chat room or not.

In an exemplary embodiment, the work chat room handling part 373 may create a one-on-one work chat room in the second dedicated container, upon receiving a request for a one-on-one chat with a particular participant about a particular task object. One-one-one chat rooms embedded into the second dedicated container may be viewed in list form on the CHECK tab of the Kanban card, along with the first work chat room associated with the Kanban card and the second work chat room associated with the task note. The work chat room handling part 373 may create an associated work chat room by default each time a new Kanban card or a new task note is created, and may create a one-on-one chat room where only certain participants can join, according to an one-on-one chat request from a participant. Moreover, the one-on-one chat room may be added to the second integration container of the Kanban board, and may be managed separately from the second dedicated container of the Kanban card.

In an exemplary embodiment, the work chat room handling part 373 may embed a notice task message containing a direct link to a task note or task object in a one-on-one work chat room so that the notice task message is always visible through the one-on-one work chat room. The one-on-one work chat room may be managed separately from the Kanban card, in which case the task note or task object of the Kanban card may be accessed via the link. The work chat room handling part 373 may provide a notice task message with a link, which is always visible on the top of the one-on-one work chat room, to provide a means of access to the task note or task object. The notice task message may be configured to be created in the form of a task message and be always visible in the work chat room. The notice task message is usually shown on the top or bottom of the chat box in the work chat room but not limited thereto, and may be shown in a predetermined area defined in the work chat room.

In an exemplary embodiment, if a participant shares a general message in the work chat room, the work chat room handling part 373 may make an inquiry to the participant about whether they are involved in the task in question or not. The work chat room handling part 373 may provide the work chat room as a space dedicated to work-related communication, and, if a certain participant shares a general message, may determine whether the participant is involved in the task in question or not. That is, the work chat room handling part 373 may display a general message differently in the work chat room, depending on whether the participant is involved in the task or not.

In an exemplary embodiment, if that participant is involved in the task in question, the work chat room handling part 373 may convert the general message into a task message by displaying the task in the general message. In this instance, the task in question displayed in the general message may contain object identification information for identifying the associated task object. In another exemplary embodiment, the work chat room handling part 373 may embed a link to the task displayed in the converted task message. The embedded link may correspond to a task link or a permanent link.

In an exemplary embodiment, if a participant shares a chat message through the first work chat room, the work chat room handling part 373 may convert the chat message into a task message by detecting a task object associated with this participant and displaying the task object in the chat message. More specifically, the first work chat room may correspond to a work chat room uniquely created for the Kanban card, and, unlike the second work chat room, all the participants in the corresponding task project may be authorized to access the first work chat room. Accordingly, chat messages shared in the first work chat room may be shared with other participants, regardless of whether they are associated with the task object. Still, the chat messages should contain additional information on which participant associated with which task object wrote the chat message. Hence, the work chat room handling part 373 may automatically convert the chat message into a task message by detecting a task object associated with the participant who wrote the chat message and displaying the corresponding task object in the chat message.

Moreover, if there are multiple task objects associated with the participant who wrote the chat message, the work chat room handling part 373 may convert the chat message into a single task message by displaying all the task objects together in the chat message, or may convert the chat message into separate task messages by displaying each task object individually in the chat message. In another exemplary embodiment, the work chat room handling part 373 may convert the chat message into a task message by displaying the task object in the chat message, and the task object displayed in the chat message may correspond to object identification information for identifying the task object.

In an exemplary embodiment, the work chat room handling part 373 may embed a task link that gives access to the corresponding task object in the process of conversion into a task message. Accordingly, the chat message entered through the first work chat room may be converted into a task message containing a task link, and the work chat room handling part 373 may provide other participants direct access to the corresponding task object as they choose.

In an exemplary embodiment, when a file is uploaded through a work chat room, the work chat room handling part 373 may handle the file as a task note or a task object according to the control of the participant. The work chat room handling part 373 may provide an interface for file uploading within the work chat room. By this, the participant has control over switching the file into a task note or task object, as well as uploading the file.

The task object handling part 375 may create a task object in the third dedicated container, the task object consisting of a task owner, a task assignee, and task details so that the participants share the assigned task. Moreover, the task object handling part 375 may provide a task object creation function through the second work chat room. Accordingly, the participants may create a task object (or task) via an interface while participating in the second work chat room. The created task object may be saved in association with the corresponding task note and the corresponding Kanban card, and may be added to the third integration container of the Kanban board and shared as an assigned task between the participants of the entire project.

Meanwhile, the task object may include an assigned task, which is a new task the task owner assigns to the task assignee in relation to the progress of a task project, and a rework task, which is a task the task owner assigns after reviewing the completed task.

In an exemplary embodiment, the task object handling part 375 may create a task object based on the workflow between the task owner and the task assignee. The task object may further include a task deadline, and the task deadline may include a start date and a due date. That is, the task object may be defined as various tasks required for the progress of a task project, and a task deadline (or due date) may be automatically set up based on the date of creation, depending on whether this task prioritizes other tasks in the workflow or not. Moreover, the task object may include the task owner who assigns the task and the task assignee who performs the task.

In an exemplary embodiment, the task object handling part 375 may manage a workflow-based task object according to its task status. The task object may further include a task status. For example, a task object created along with the progress of a task project may include one of the following task statuses: new, doing, done, and confirmed. In another example, the task status may be defined as the following phases of work progress: in progress, under review, reworking, and rework completed.

That is, the task object handling part 375 may monitor the progress of a task object, update the status of the task object along with the progress of work, and provide information on the progress of the task object. The participants may see a list of task objects associated with the corresponding task project through the third dedicated container of the Kanban card, see the status of each individual task by accessing each task object, and see the current progress and statuses of task objects associated with the entire project through the third integration container of the Kanban board.

The controller 390 may control the overall operation of the work processing device 130 and manage the control flow or data flow between the Kanban board handling part 310, the Kanban card handling part 330, the work container handling part 350, and the work handling part 370.

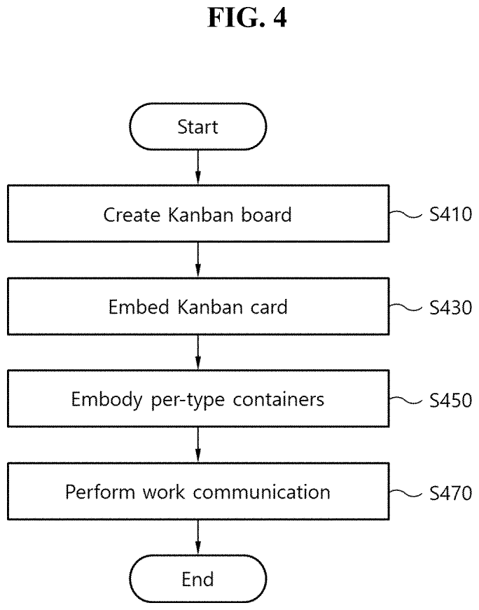

FIG. 4 is a sequential chat of a Kanban-based work processing method according to the present disclosure.

Referring to FIG. 4, the work processing device 130 may create a user-based Kanban board for the management of an entire project through the Kanban board handling part 310 (Step S410). The Kanban board may include first through third integration containers which provide integrated management of task notes, work chat rooms, and task objects created in association with multiple Kanban cards. The first through third integration containers may correspond to DO, CHECK, and ACT tabs.

Afterwards, the work processing device 130 may create a task project in response to a user signal from the user terminal 110, and may create a Kanban card for the created task project through the Kanban card handling part 330 and embed it into the Kanban board (step S430).

Moreover, the work processing device 130 may embody per-user-defined-work-type containers which associate the Kanban card with the task project through the work container handling part 350 (Step S450). The work processing device 130 may perform user-defined work-based work communication between participants through a user-defined work container, which is one among the per-user-defined-work-type containers, through the work handling part 370 (Step S470).

Moreover, the work processing device 130 may create a reminder message with the progress of the task project associated with the Kanban card through the work handling part 370 and allow it to be shared through the work chat room. For example, a reminder message created by the work handling part 370 may be created according to an occurrence interval or deadline for a task note in the Kanban card and provided to associated participants. That is, the work handling part 370 create the reminder message to send to at least some participants by setting reminders to periodically create task notes or reminders for a workflow-based deadline of a task object.

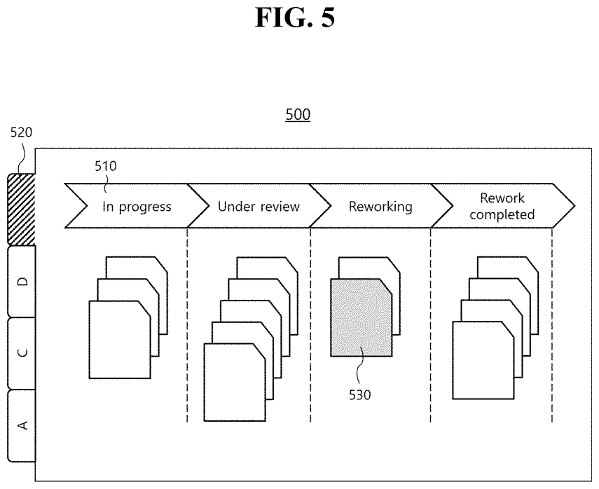

FIG. 5 is a view illustrating a Kanban board according to an exemplary embodiment of the present disclosure.

Referring to FIG. 5, the work processing device 130 may visualize Kanban cards 530 according to the phases 510 of work progress through the Kanban board 500. The Kanban cards 530 may be sorted and arranged according to the phases 510 of work progress, but are not limited thereto and may be organized according to various criteria such as department, task owner, task assignee, deadline, and workflow.

According to an exemplary embodiment, the details of a task may be uploaded onto the “in-progress” Kanban cards 530, and a completed task may be uploaded onto the ‘under review” Kanban cards. Also, when the task assignee or the task owner chooses one of the Kanban cards 530, the work processing device 130 may provide a user interface for the corresponding Kanban card. In this case, the user interface may provide various features (e.g., WRITE, UPLOAD, DELETE, CREATE CHAT ROOM) associated with the Kanban card 530.

For example, the user may access a detailed view of the Kanban card 530 via the user interface, or may access a task note, work chat room, and task object associated with the corresponding task project. Also, the task owner may enter a rework instruction for the completed task through a work chat room associated with the Kanban card 530. The task owner may enter a rework instruction through a work chat room associated with a particular task note in order to give a more detailed instruction. In this case, a new task object for the rework instruction may be created and uploaded onto the corresponding Kanban card 530. Also, the Kanban card 530, which is updated along with the creation of a new task object, may appear different from the other Kanban cards with no new issues in thickness, brightness, color, etc. on the Kanban board 500.

Meanwhile, the Kanban board 500 may include various tabs, apart from a Kanban card area 520 showing the Kanban cards 530. For example, the Kanban board 500 may include D(DO), C(CHECK), and A(ACT) tabs, and each tab may show a list of task notes (or a list of files), a list of work chat rooms, and a list of task objects (or a list of tasks) that belong to the Kanban board 500.

Moreover, the D, C, and A tabs of the Kanban board 500 may correspond to the first through third integration containers. That is, the task notes that can be viewed on the D tab may be embedded into the first integration container for management, the work chat rooms that can be viewed on the C tab may be embedded into the second integration container for management, and the task objects that can be viewed on the A tab may be embedded into the third integration container for management.

Additionally, the task notes, work chat rooms, and task objects (or tasks) on the lists displayed on the tabs may include links to their associated Kanban cards 530. That is, the user may have quick access to the corresponding Kanban cards 530 just by choosing a particular item on the lists. Also, the task notes, the work chat rooms, and the task objects may include permanent links for external sharing. In this case, the user may have direct access to them by selecting a particular item on the lists.

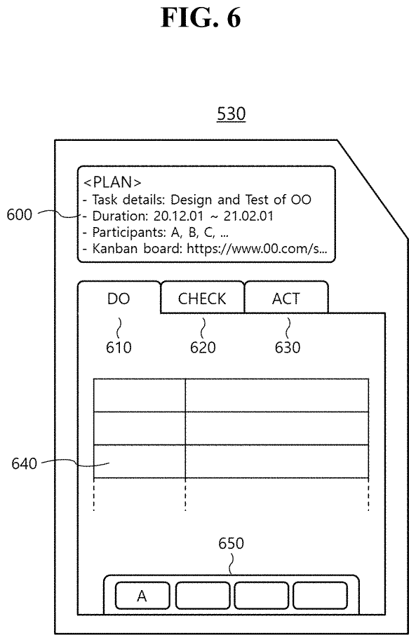

FIG. 6 is a view illustrating a Kanban card according to an exemplary embodiment of the present disclosure.

Referring to FIG. 6, when a new task project is created in a Kanban board, the work processing device 130 may create a Kanban card 530 for the management of the task project and embed it. The created Kanban card 530 may be visually displayed on the Kanban board, and a participant may choose a particular Kanban card 530 and move to the detailed view.

The detailed view of the Kanban card may include a plan area 600, a DO tab 610, a CHECK tab 620, an ACT tab 630, etc. The DO tab 610 may correspond to a first dedicated container, the CHECK tab 620 may correspond to a second dedicated container, and the ACT tab 630 may correspond to a third dedicated container. The plan area 600 may show a brief explanation of the corresponding Kanban card 530. For example, the plan area 600 may show information on the task details, duration, participants, Kanban board, etc. of the Kanban card 530.

Moreover, the Kanban card 530 may present lookup information in the form of a task note list 640 on each tab. For example, the DO tab 610 may provide a list of task notes. The list of task notes may correspond to a list of task notes entered throughout the process of the task project. The list of task notes may include information on registered files as task notes, as well as task notes.

The CHECK tab 620 may provide a list of work chat rooms. The list of work chat rooms may correspond to a list of work chat rooms created throughout the process of the task project. For example, the list of work chat rooms may include a first work chat room uniquely associated with the Kanban card 530, a second work chat room created for each task note, and an one-on-one work chat room created in response to a one-one-one chat request.

The ACT tab 630 may provide a list of task objects. The list of task objects may correspond to a list of task objects created throughout the process of the task project. The task objects in the list may appear different according to the phases of work progress. For example, the task objects may be classified and marked as new (S1), doing (S2), done (S3), and confirmed (S4) on the list.

Moreover, the work processing device 130 may provide a unique interface 650 on each tab. Each interface 650 may include commands for items managed in the tab. For example, each interface 650 may include commands for creating, modifying, and deleting items.

In addition, actions performed through each tab may be shared as task messages (or system messages) through a work chat room. For example, for a task note created in the DO tab, a task message (or system message) about the creation of the task note may be created and shared through the first work chat room. For a task object created in the ACT tab, a task message (or system message) about the creation of the task object may be created and shared through the first work chat room or the second work chat room.

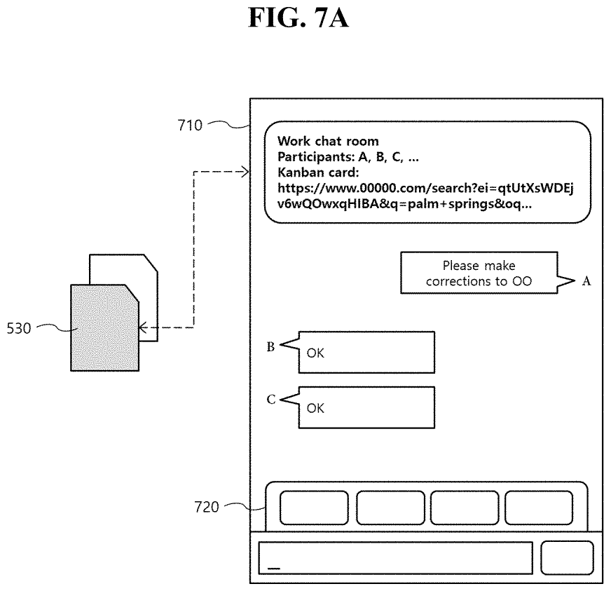

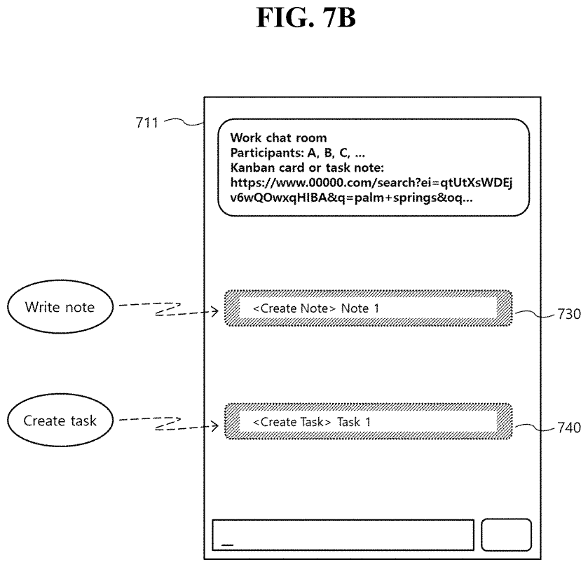

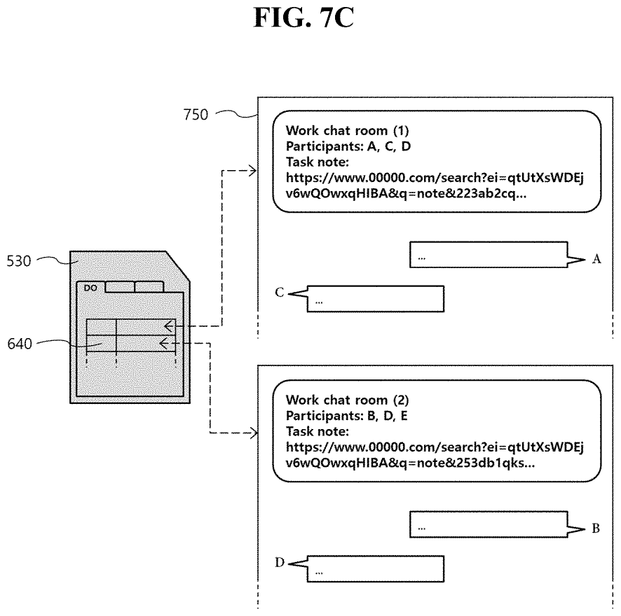

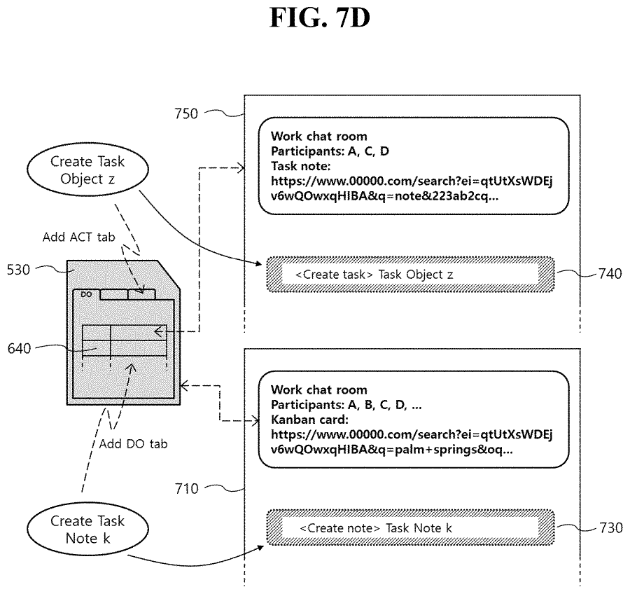

FIGS. 7A-7D are views illustrating work chat rooms and a reminder sharing process.

Referring to FIG. 7A, the work processing device 130 may create one work chat room (i.e., first work chat room) 710 corresponding to a particular Kanban card 530 by default. Various operations may be performed within the work chat room 710, including writing on task notes, uploading files, typing chat messages, and creating task objects (tasks). To this end, a separate interface 710 for various features may be provided within the first work chat room 710. Meanwhile, a second work chat room for a task note may have the same features as the first work chat room 710.

Subsequently, the first work chat room 710 may provide logs of all activities associated with the Kanban card 530 in chronological order as task messages within the chat room, thereby enabling the participants to easily understand the progress of work.

As shown in FIG. 7A, a rework instruction may be entered through the first work chat room 710. Also, the rework instruction entered through the first work chat room 710 may be automatically uploaded in real time onto the corresponding Kanban card 530, so that the progress of work through the first work chat room 710 may be shared and synchronized in real time with the Kanban card 530 associated with the first work chat room 710.

Meanwhile, although FIG. 7A illustrates an exemplary embodiment in which a rework instruction is entered through the first work chat room 710, a reworked task, once finished after the rework instruction is given, may be likewise entered through the first work chat room 710 and uploaded onto the Kanban card 530 according to another exemplary embodiment. In yet another exemplary embodiment, task details or a completed task may be entered through the first work chat room 710 and then uploaded onto the associated Kanban card 530 which is in the “in-progress” or “under review” phase.

After a rework instruction and a reworked task are entered through the first work chat room 710, once the task assignee confirms or approves the reworked task, the confirmation or approval is reflected in the corresponding Kanban card 530, and the Kanban card 530 may move to the “rework completed” phase. Meanwhile, the same may apply to second work chat rooms related to task notes, as it does to the first work chat room 710.

Referring to FIG. 7B, the work processing device 130 may provide one first work chat room 710 for each Kanban card and one second work chat room 750 for each task note. That is, a work chat room 711 may be created in connection with a Kanban card or a task note, and each associated participant may perform various types of work communication associated with the task in question through the work chat room 711. For example, when a task note or a task object (or task) is created, task messages 730 and 740 associated with this creation may be created and shown through the work chat room 711.

In this case, a task note may be created within the first work chat room 710, and a task object may be created within the first and second work chat rooms 710 and 750. Besides, a task note and a task object may be created within the DO tab or ACT tab of the Kanban card as well. In either case, the task messages 730 and 740 about the related operations may be displayed through the work chat room 711. Accordingly, the participants may see the flow of the work in chronological order by viewing the task messages within the work chat room 711.

Referring to FIG. 7C, the work processing device 130 may share task messages about task objects through the second work chat room 750. Also, the task messages shared through the second work chat room 750 may be automatically uploaded in real time onto the corresponding Kanban card 530. Also, task notes may be managed in list form through the DO tab of the Kanban card 530, and the second work chat room 750 may be created and managed for each task note 640. That is, with a second work chat room 750 uniquely associated with each task note 640, records on the task note 640 may be created as task messages and shared with the participants through the second work chat room 750.

Referring to FIG. 7D, the work processing device 130 may provide one first work chat room 710 for each Kanban card 530 and one second work chat room 750 for each task note 640 by default. Accordingly, in a case where multiple task notes 640 are created, multiple second work chat rooms 750 may be created. The participants may perform various types of work communication associated with the corresponding task project and the corresponding task note 640 through the first work chat room 710 and the second work chat room 750, respectively.

For example, when a task object (or task) is created, a task message 740 associated with this creation may be created and shown through the second work chat room 750, and when a task note 640 is created, a task message 730 associated with this creation may be created and displayed through the first work chat room 710. In this instance, the created task note 640 and task object may be embedded into the first and third dedicated containers of the Kanban card 530 for management, and may be viewed on the DO tab and the ACT tab, respectively.

Meanwhile, the task note 640 or task object may be created within the first work chat room 710 or the second work chat room 750, or may be created within the DO tab or ACT tab of the Kanban card 530. In either case, the task messages 730 and 740 about the related operations may be displayed through their corresponding work chat rooms. Accordingly, the participants may see the flow of the task project or the flow of tasks in chronological order by viewing the task messages within the work chat room 711.

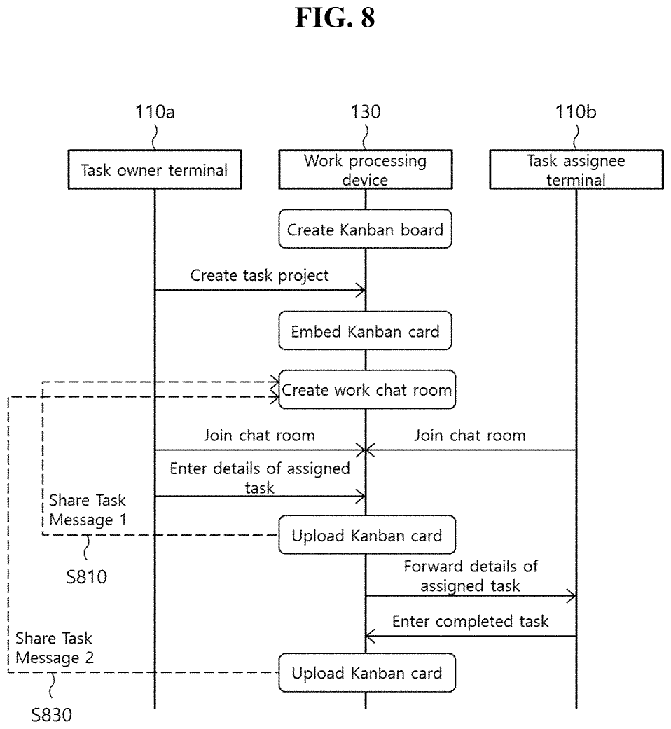

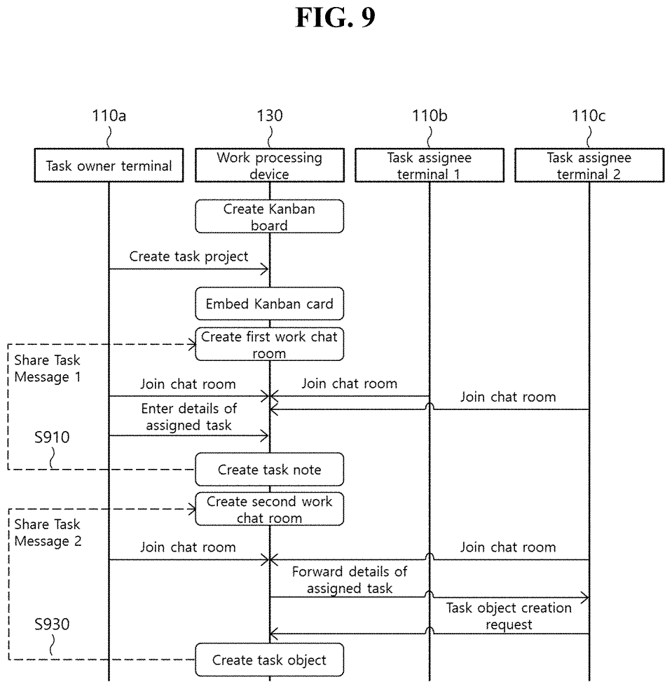

FIGS. 8 and 9 are flowcharts illustrating various examples of sharing task messages in a Kanban-based work processing process according to the present disclosure.

Referring to FIG. 8, the work processing device 130 may create a Kanban board associated with an entire project. The work processing device 130 may receive a user signal requesting the creation of a Kanban board from a user terminal 110 in the previous step.

Moreover, a Kanban board may include a user interface (UI) for performing various functions. The user interface is a UI for supporting collaborative work through a Kanban board or a Kanban card. The UI may include commands for receiving user signals, such as creating a work chat room, specifying chat room participants, simple sharing of the Kanban board, entering work material associated with the Kanban board, viewing chat rooms, reading a document, or attaching a document.

A task owner terminal 110a may create a task project. The task owner terminal 110a may have an interface provided by the work processing device 130. Once a task project is created, the work processing device 130 may create a Kanban card and embed it into the Kanban board. Afterwards, the work processing device 130 may create a work chat room corresponding to the Kanban card. That is, a work chat room may be created for each Kanban card, and manage task logs for the task project associated with the Kanban card.

Meanwhile, a work chat room may be created at a time when a Kanban card is created, but not limited thereto. Also, even when a Kanban card is created, the work processing device 130 may wait for the creation of a work chat room until there is a separate request signal from the user terminal 110. Accordingly, task details or a completed task may have been already uploaded onto the Kanban board or Kanban card before the creation of a work chat room.

After the creation of a work chat room, the participants, including the task owner terminal 110a and the task assignee terminal 110b, may participate in the work chat room. Afterwards, the task owner terminal 110a may enter task details through the work chat room. The task details entered through the work chat room may be displayed in the form of a task message. The work processing device 130 may create a task object according to the task details entered by the task owner terminal 110a, and this task object may be uploaded and registered on the Kanban card.

In this instance, the task object may be created not only in the work chat room but also in the Kanban card, in which case a task message about the creation of the task object may be created. The task message may be displayed through the work chat room and shared with other participants (S810).

Once task details are uploaded onto the Kanban card, the work processing device 130 may forward the task details to the task assignee terminal 110b. The task assignee may perform the work according to the task details received from the task owner through the work processing device 130, and may enter their completed task into the work processing device 130. The completed task entered by the task assignee terminal 110b may be entered through the work chat room, and may be uploaded onto the Kanban card by the work processing device 130.

For example, in a case where the task assignee sends a file object corresponding to a completed task through the work chat room, the work processing device 130 may upload this file object onto the Kanban card associated with the work chat room.

In this instance, the completed task may be entered not only through the work chat room but also in the Kanban card, in which case a task message about the entry of the completed task may be created. The task message may be displayed through the work chat room and shared with other participants (S830).

Afterwards, the task owner may check the completed task uploaded by the task assignee and enter a rework request if there is a part that requires rework. The rework request may be entered through the work chat room. Once the task owner enters a rework request, the work processing device 130 may upload the rework request onto the Kanban card and provide the rework request to the task assignee terminal 110b.

Moreover, in a case where there is a deadline set in the rework request—that is, the rework request contains information about the deadline, the work processing device 130 may create a rework reminder message. That is, as the deadline draws near, the work processing device 130 may create a rework reminder message and provide it to the task assignee terminal 110b through the work chat room.

Once the task assignee receives the rework request and the rework reminder message through the task assignee terminal 110b, they may modify, edit, alter, or rewrite the task according to the rework request and enter the reworked task. The reworked task may be entered directly into the Kanban card or entered through the work chat room. Upon receiving the reworked task from the task assignee terminal 110b, the work processing device 130 may upload the received reworked task onto the corresponding Kanban card.

Referring to FIG. 9, the work processing device 130 may create a Kanban board, and the task owner terminal 110a may create a task project. Once a task project is created, the work processing device 130 may create a Kanban card and embed it into the Kanban board.

Afterwards, the work processing device 130 may create a first work chat room corresponding to the Kanban card. The first work chat room may be created and managed separately from a second work chat room corresponding to a task note. That is, the first work chat room may be created uniquely for each Kanban card and manage task logs for the task project associated with the Kanban card.

After the creation of the first work chat room, the participants, including the task owner terminal 110a, a first task assignee terminal 110b, and a second task assignee terminal 110c, may participate in the first work chat room. Afterwards, the task owner terminal 110a may enter task details through the first work chat room. The work processing device 130 may receive the entered task details as a signal requesting the creation of a task note and create a task note. Once a task note is created, the work processing device 130 may share Task Message 1 about the created task note through the first work chat room (S910).

Moreover, once the task note is created, the work processing device 130 may create a second work chat room associated with the corresponding task note. Only the participants associated with this task note can join the second work chat room. As shown in FIG. 9, the participants corresponding to the task owner terminal 110a and the second task assignee terminal 110c may join the second work chat room, and the participant corresponding to the first task assignee terminal 110b may be restricted from joining the chat room.

The task details entered by the task owner may be forwarded to the participant corresponding to the second task assignee terminal 110c through the second work chat room, and this participant may request to create a task object to perform the task. The work processing device 130 may create a task object in response to the request, and the task object may be uploaded and registered onto the Kanban card. In this case, Task Message 2 about the created task object may be displayed through the second work chat room and shared with other participants (S930).

Moreover, as the work progresses, a completed task may be entered through the second task assignee terminal 110c and reflected in the task object, and a task message about this may be created and shared with other participants through the second work chat room.

Meanwhile, in a case where there is a deadline set in the details of a task—that is, a deadline associated with a task note, if there is no update made to the task note (e.g., there is no record on the task note) even till the expiry of the deadline, the work processing device 130 may create a task reminder message. In this instance, the task note may contain information about the deadline, and the deadline for each task note may be managed through the Kanban card (plan). Consequently, if a deadline is approaching or expires, the work processing device 130 may create a task reminder message and share it as a task message through the first work chat room or the second work chat room, thereby bringing a sense of urgency about the task associated with the task note to the participants.

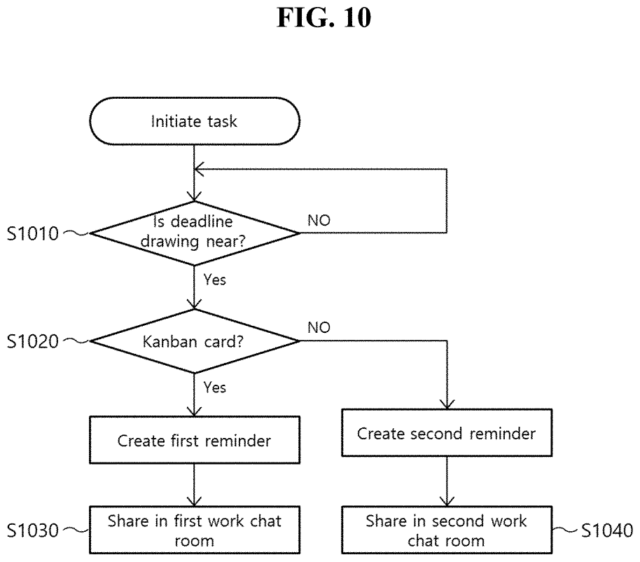

FIG. 10 is a view illustrating a reminder sharing process according an exemplary embodiment of the present disclosure.

Referring to FIG. 10, the work processing device 130 may create a Kanban board for the management of an entire project. In the Kanban board, a Kanban card may be created and embedded into the Kanban board to manage a task project, and a first work chat room uniquely associated with the created Kanban card may be created. The created first work chat room may be embedded into a second integration container of the Kanban board for management.

As a Kanban card is created, the work on an associated task project may be initiated, and deadlines maybe set for the Kanban card, task notes, and task objects.

As a deadline is drawing near (for example, 3 days before the deadline), the work processing device 130 may create and send an associated reminder message (S1010). For example, the work processing device 130 may detect whether the deadline is associated with the Kanban card or not (Step S1020), and if so, may create a first reminder message and allow it to be shared through the first work chat room (S1030). In a case where the deadline is associated with a task note, a second reminder message may be created and shared through the second task chat room (S1040). If the deadline is associated with a task note, it may mean that the deadline of a task object included in the task note is drawing near.

For example, in a case where there is a deadline set in the details of a task—that is, a deadline for writing periodically task notes, if no task note has been written even till the expiry of the deadline, the work processing device 130 may create a reminder message (or first reminder) about the task.

Consequently, the work processing device 130 may create a reminder message and allow it to be shared through a work chat room as a deadline is drawing near or has expired in relation to the progress of work, and therefore may efficiently bring a sense of urgency about the task to the participants.

Meanwhile, the work processing device 130 according to the present disclosure may provide an effective tool for carrying out and managing a project through a Kanban board and Kanban cards. Moreover, the work processing device 130 may provide dash boards for the Kanban board and Kanban cards. More specifically, the dashboard for the Kanban board may provide a statistical analysis of the Kanban boards P(PLAN), D(DO), C(Check), and A(ACT) in the Kanban board, and the dashboards for the Kanban cards may provide analytical information on the Kanban cards (P) and a statistical analysis of the D, C, and A in each of the Kanban cards.

While the present disclosure has been described above with reference to the exemplary embodiments, it may be understood by those skilled in the art that the present disclosure may be variously modified and changed without departing from the spirit and scope of the present disclosure disclosed in the claims.

The disclosed technique may have the following effects. Provided that, since it is not meant to imply that a particular embodiment should include all of the following effects or only the following effects, the scope of the disclosed technology is not to be construed as limited thereby.

According to an exemplary embodiment of the present disclosure, the user is able to see at a glance the progress of an ongoing project through a Kanban board, to give feedback on tasks and rework them in an effective way through a chat room uniquely associated with a Kanban card and a separate chat room associated with a task note, and to easily understand the workflow through task messages shared in chronological order, thereby improving the efficiency of work.

Particularly, task messages shared within a chat room associated with a Kanban card through this process make it possible to save and manage records in one place throughout the course of the task and therefore facilitate communication between the participants, and these task messages provide links for easy access as well, thereby improving user convenience.

1. A Kanban-based work processing device comprising:
a Kanban board handling part that creates a new Kanban board;
a Kanban card handling part that embeds a Kanban card for a created task project into the Kanban board;
a work container handling part that embodies per-user-defined-work-type containers which associate the Kanban card with the task project; and
a work handling part that performs user-defined work-based work communication between participants through a user-defined work container, which is one among the per-user-defined-work-type containers.

2. (canceled)

3. (canceled)

4. The Kanban-based work processing device of claim 1, wherein the work container handling part assigns a unique identity link to the user-defined work container and supports direct transitions between the per-user-defined-work-type containers through the user-defined work.

5. The Kanban-based work processing device of claim 1, wherein the work container handling part implements one of the per-user-defined-work-type containers as a work chat room-only container.

6. The Kanban-based work processing device of claim 5, wherein the work handling part embodies a work chat room associated with the task project in the work chat room-only container.

7. The Kanban-based work processing device of claim 6, wherein the work handling part embodies a user-defined work chat room associated with the user-defined work in the work chat room-only container.

8. The Kanban-based work processing device of claim 6, wherein the work handling part implements the user-defined work by a text or binary file-based task message and provides the task message to the work chat room.

9. The Kanban-based work processing device of claim 8, wherein, when an event occurs from other user-defined work, the work handling part implements the user-defined work by a system message and provides the task message to the work chat room.

10. The Kanban-based work processing device of claim 8, wherein the work handling part registers a reminder event by tracking the progress of a conversation in the task message.

11. The Kanban-based work processing device of claim 1, wherein the work container handling part implements one of the per-user-defined-work-type containers as a task note-only container.

12. The Kanban-based work processing device of claim 11, wherein the work handling part implements the user-defined work by a text or binary file-based task note and curates the task note in the task note-only container according to user settings.

13. The Kanban-based work processing device of claim 12, wherein the work handling part creates a task note event when the task note is created.

14. The Kanban-based work processing device of claim 1, wherein the work container handling part implements one of the per-user-defined-work-type containers as a task object-only container.

15. The Kanban-based work processing device of claim 14, wherein the work handling part implements the user-defined work by a task object and implements the task object in the task object-only container.

16. (canceled)

17. The Kanban-based work processing device of claim 15, wherein the work handling part registers a reminder event by tracking the progress of work in the task object based on workflow.

18. The Kanban-based work processing device of claim 1, wherein the work handling part detects the registration of a reminder event that has occurred from the user-defined work.

19. The Kanban-based work processing device of claim 18, wherein the work handling part creates a reminder setting for the reminder event and provides a reminder message to the work chat room according to the reminder setting.

20. The Kanban-based work processing device of claim 19, wherein the work handling part creates a reminder message by setting a reminder for the status of progress of user-defined work assigned to at least some of the participants of the task project.

21. The Kanban-based work processing device of claim 20, wherein the work handling part updates the reminder message based on the number of repetitions of the same reminder message.

22. The Kanban-based work processing device of claim 21, wherein, if a plurality of tasks are sequentially linked according to a sequence of work, the work handling part creates an integrated reminder message reflecting the sequence of work and allows the same to be shared through the work chat room.

23. (canceled)

24. A Kanban-based work processing method comprising:
creating a new Kanban board;
embedding a Kanban card for a created task project into the Kanban board;
embodying per-user-defined-work-type containers which associate the Kanban card with the task project; and
performing user-defined work-based work communication between participants through a user-defined work container, which is one among the per-user-defined-work-type containers.
